(19) United States
(12) Patent Application Publication
(10) Pub. No.: US 2007/0069876 A1
(43) Pub. Date: Mar. 29, 2007

(54) Tire pressure system

(76) Inventors: Philip H.W. Leong, Kowloon (HK); Wen J. Li, Taipo (HK)

Correspondence Address: Curt Harrington, Suite 250, 6300 State University Drive, Long Beach, CA, 90815, US

(21) Appl. No.: 11/237,592

(22) Filed: Sep. 27, 2005

(51) Int. Cl. B60C 23/02

(52) U.S. Cl. 340/442

(57) ABSTRACT

A pressure system for monitoring the pressure in tires and other pressurized devices, is mounted in a position to receive pressure. A tire monitoring device structure is provided in which an average user can attach to the tire pressure stem. Internal pressure is monitored and transmitted to a receiver which is programmable to receive the signal and utilize it to provide information and warnings to the vehicle operator should the tire pressure (1) attain a value outside tolerance limits, or (2) become unmatched beyond relative tolerance limits.

### FIELD OF THE INVENTION

The present invention relates to a convenient, simple to install tire pressure monitoring system, and more particularly to a valve stem mounted tire pressure sensing and transmission structure with extremely low power consumption.

### BACKGROUND OF THE INVENTION

A number of tire pressure systems are known, most of which have a highly integrated dependence upon the vehicle in which they were installed. Sensors and transmitters which are mounted at the inside of car frames require inclusion with the original automobile frame when the automobile is manufactured, or extensive mounting, calibration and specialized labor cost.

### SUMMARY OF THE INVENTION

A pressure system for monitoring the pressure in tires and other pressurized devices, is mounted in a position to receive pressure. A tire monitoring device structure is provided in which an average user can attach to the tire pressure stem. Internal pressure is monitored and transmitted to a receiver which is programmable to receive the signal and utilize it to provide information and warnings to the vehicle operator should the tire pressure (1) attain a value outside tolerance limits, or (2) become unmatched beyond relative tolerance limits.

The device for measuring a single tire pressure is threadably attached on the valve stem of a user's tire a mechanical pressure gauge on the apparatus is used to sense the pressure inside the tire. A receiver's display can enable the user to get an instant overall view of the status of the tires, as well as to give the user the ability to predict the need for periodic maintenance and pressure adjustment. A change of tire or replacement of the pressure sensing and transmitting unit can be accompanied by the re-start of a mileage counter, either internal or in the receiver.

The power consumption for the sensor and transmitters has been brought to a level sufficiently low that batteries need never be changed or that batteries are eliminated. A hybrid version which utilizes batteries as a power storage reservoir is also preferable.

Power for the device can be provided by battery or by other power generation and storage structure, or by a combination of both. The tire environment includes external exposure, motion and vibration, and power generation sources can include solar, vibration, centripetal, and wind movement.

Where absolute minimum cost is desired, as well as only an indication of tire pressure falling below an absolute minimum, an arrangement where the magnitude of air pressure pushing against an object, which may include a plunger compressing a spring, or a more direct pressure measuring component. In the case of a plunger, a mechanical switch may be placed underneath a plunger which rises against a spring when sufficient tire pressure is present. Where the tire pressure drops, the plunger is guided by the spring to trip a switch.

Most versions will depress the valve stem main pressure admittance pin, in order to admit pressurized air into fluid contact with the pressure transmitter. The attachment should be sufficient to hold the pressure and prevent its leaking to the environment, and thus the internal threads will be sufficiently strong and sealing surfaces will have sufficient surface area to hold the pressure. To add pressure to a tire having the pressure transmitter described herein, the tire pressure transmitter is simply threadably removed, the tire filled and then the tire pressure transmitter is replaced. In terms of orientation and style, the pressure transmitter will appear to the essentially the same as a valve stem cap. This will prevent vandalism and theft as tire valve stem caps are rarely disturbed by vandals and thieves.

Other embodiments may include a separate upper valve so that the tire pressure transmitter will provide an air pressurization inlet and will, in fact, operate as a valve extension.

A central receiver receives a signal from each transmitter which is coded in accord with its position on the vehicle. The pressure transmitter may be numbered to help the user install the tire pressure monitor on the correct tire which should relate to any schematic of the tire location seen on the monitor. An alarm system can include beeps or other audible warnings of tire pressure outside the normal threshold.

### BRIEF DESCRIPTION OF THE DRAWINGS

The invention, its configuration, construction, and operation will be best further described in the following detailed description, taken in conjunction with the accompanying drawings in which:

FIG. 1 is a perspective view of one embodiment of a rudimentary tire pressure sensor which uses a diaphragm actuated switch to indicate a tire under-pressure condition;

FIG. 2 is a perspective view from the other side of the rudimentary tire pressure sensor seen in FIG. 1;

FIG. 3 is an exploded view of the components contained within the main mechanical barrel section of the sensor seen in FIGS. 1 and 2;

FIG. 4 is a bottom view of the electronics housing support seen in FIGS. 1 and 2;

FIG. 5 is a first side view of the electronics housing support seen in FIGS. 1, 2, and 4;

FIG. 6 is a second side view of the electronics housing support seen in FIGS. 1, 2, 3, and 4;

FIG. 7 is a bottom view of an electronics housing cover which interfits with the electronics housing support seen in FIGS. 4, 5, and 6;

FIG. 8 is a side view of the electronics housing cover seen in FIG. 7; and

FIG. 9 is a plan view of a tire counter weight.

### DETAILED DESCRIPTION OF THE PREFERRED EMBODIMENT

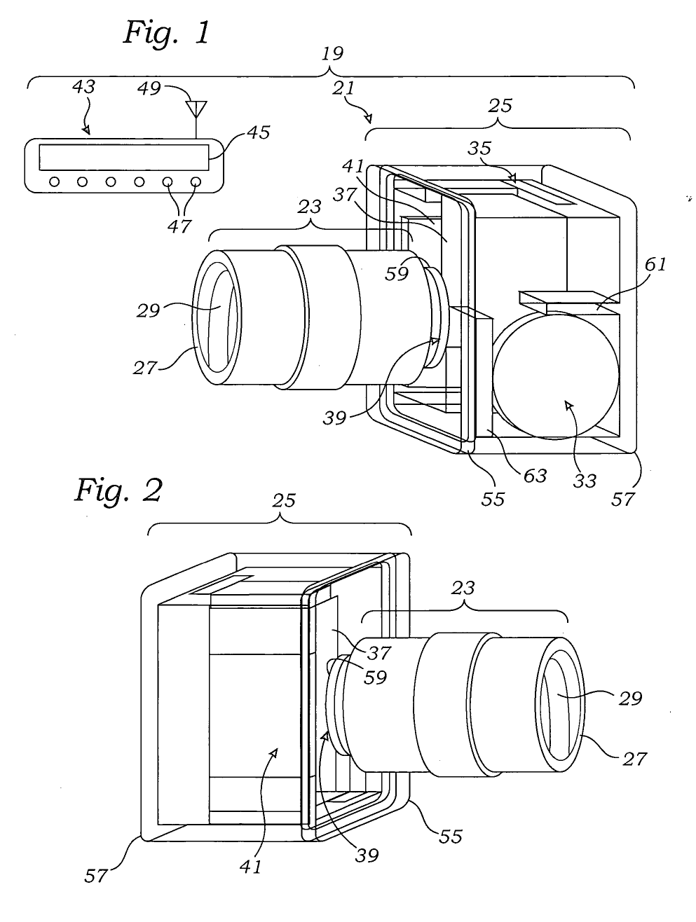

Referring to FIG. 1, a perspective of one possible embodiment of a tire pressure sensor system 19 and including a tire pressure sensor 21 is seen. The tire pressure sensor 21 has two main parts, a mechanical barrel assembly 23 and an electronics housing section 25. The mechanical barrel assembly 23 has an open end 27 having an internally threaded surface 29 for engaging the externally disposed threads of a conventional tire pressure valve.

Some components can be seen in the electronics housing section 25, including a battery 33, which may be a commercially available battery 33 having a serial number CR1025.

A printed circuit board 35, is connected to the battery 33 and may include a variety of electronics components. A transducer 37 is electrically connected o the printed circuit board 35. The layout of the electronics housing section 25 will preferably be about 21 millimeters by 21 millimeters by about 13.5 millimeters high. The axial length of the mechanical barrel assembly 23 is about 15.5 millimeters. This results in an overall assembly which is about 29 millimeters high, but which extends above a conventional tire pressure stem only about 21.5 millimeters. The volume, length and width and weight of tire pressure sensor is important as a sensor should be able to be installed by a consumer onto the tire valve stem, and the addition of weight should not be sufficient to significantly affect the tire's balance.

A axial displacement member 39 is partially shown. This member transmits the pressure to the switch by means of axial displacement in the direction of the transducer 37. In the simplest embodiment, the transducer 37 can be a simple switch which is set to close or open upon a given displacement or pressure. In more complex embodiments, the transducer 37 can have a pressure-displacement characteristic which may be linear or which may be linearized or calibration interpreted by associated circuitry. A wireless transmission chip 41 is in electronic communication with the printed circuit board 35 and communicates with a receiver 43.

Receiver 43 should at minimum have a display 45 with a minimum number of buttons 47 for either programming or for selection of which of the tire pressure sensors 21 characteristics are be displayed. Receiver 45 should have an antenna 49 compatible with any transmissive structure of the transmission chip 41.

Also seen in FIG. 1 are details of the housing 25. A base 55 interfits with a cover 57. The cover is slightly seen as being connected to mechanical barrel assembly 23 via an annular projection 59 which is continuous with the base 55. The cover 57 may have a number of internal projections including a first projection 61 which is seen as providing some boundary for the battery 33. A base member 63 extends from the base 55 and further helps to support the battery 33. The remaining support for the battery 33 is seen in the broad side surface of the cover 57 and a top surface. Referring to FIG. 2, a view of the tire pressure sensor 21 seen from the opposite view illustrates a more complete rendering of the structures seen in FIG. 1.

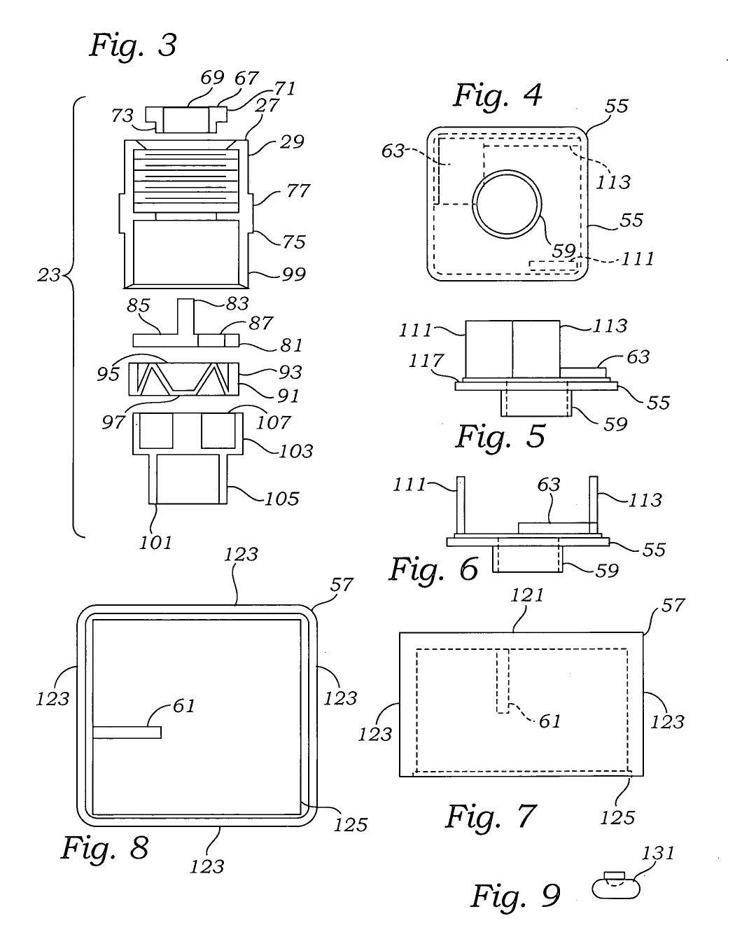

Referring to FIG. 3, an exploded view of the mechanical barrel assembly 23 seen in FIGS. 1 and 2 is seen. At the top is a pressure washer 67 having a through bore 69 and a circumferentially more outwardly located portion 71 with respect to a circumferentially more inwardly located portion 73 which will fit through an aperture 75 in a wall 77 within the mechanical barrel assembly 23. Pressure washer 67 helps to seal with respect to a conventional tire pressure fitting and to insure that the pressure from a tire which is to be measured travels through the center of the pressure washer 67 and does not leak through the space adjacent the threads 29 and cause eventual deflation of the tires.

On the other side of the wall 77 and extending partially through the aperture 75 is a pressure pin 81 having a pressure pin projection 83 and a round support plate 85. The round support plate 85 carries a pressure aperture 87. The pressure pin projection extends through the aperture 75 and the bore 69 to both come into contact with and urge a conventional tire valve pressure valve pin to admit pressurized air into the mechanical barrel assembly 23 so that it can be sensed by the tire pressure sensor 21.

Next seen in FIG. 3 is a pressure displacement diaphragm 91. Pressure displacement diaphragm 91 serves to transmit a mechanical indication of pressure, but without allowing air flow beyond the pressure displacement diaphragm 91. Pressure displacement diaphragm 91 has a relatively thicker peripheral wall 93 continuous with a circumferentially angled membrane 95, which has a general “W” shape as seen in cross section in FIG. 3. The center of the membrane 95 has a flat area 97. The diameter of the relatively thicker peripheral wall 93 may preferably exceed an internal diameter of a surface 99 seen in mechanical barrel assembly 23 so that the pressure displacement diaphragm 91 forms a good tight fit within the mechanical barrel assembly 23 and so that no significant leakage around the pressure displacement diaphragm 91 takes place.

To provide error free operation, a transducer pushing structure 101 is positioned adjacent the pressure displacement diaphragm 91. Transducer pushing structure 101 has a first diameter portion 103. A second diameter portion 105 is sized to effectively abut the transducer 37. The cross section of first diameter portion 103 reveals an annular projection 107 which has a cross sectional diameter roughly equivalent to the cross sectional diameter of flat area 97 of the membrane 95 of the pressure displacement diaphragm 91. This insures a well supported and even force movement of the transducer pushing structure 101.

Referring to FIG. 4, a bottom view of the base 55 of the electronics housing section 25 illustrates the prominent annular projection 59. In general, the annular projection 59 will be attached to the inside surface 99 of the mechanical barrel assembly 23. In turn, the second diameter portion 105 of the transducer pushing structure 101 will axially slide within the annular projection 59. Ideally, the outer diameter of the annular projection 59 will fit snugly within the interior diameter of the mechanical barrel assembly 23 adjacent the inside surface 99. As such, the face of the annular projection 59 will abut the upper radial surface of the peripheral wall 93 and help to hold the pressure displacement diaphragm 91 securely in place. The second diameter portion 105 of the transducer pushing structure 101 then moves through and has an outer diameter smaller than the inside diameter of the annular projection 59. Further, because the pressure displacement diaphragm 91 is also a pressure barrier, the electronics housing section 25 will not be otherwise pressure urged out of the mechanical barrel assembly 23. So long as the pressure displacement diaphragm 91 and annular projection 59 are firmly in place the displacement of the transducer pushing structure 101 will be solely due to the displacement of the membrane 96 within the pressure displacement diaphragm 91. Also seen in FIG. 4 are the base member 63 which formed a lower support for the battery 33. Other spacing structures are seen and also shown in dashed line format including structures 111 and 113.

Referring to FIG. 5 a plan view of the base 55 is seen. A groove 117 is seen which will be used to make an exact fit with the cover 57. FIG. 6 illustrates a plan view from a different angle, with FIGS. 4, 5, & 6 illustrating a complete view of the base 55.

Referring to FIG. 7, a plan view of the cover 57 is seen. The thickness of the cover 57 is indicated by the dashed line about the upper periphery of the top 121 and the sides 123. At the bottom a chamfer 135 is configured to interfit with the groove 117. The chamfer extends around the base 55. Also seen in dashed line format is the first projection 61 previously seen in FIG. 1.

Referring to FIG. 8, a view looking into the cover 57 shows that the chamfer 235 extends completely around the inner periphery of the cover 57. The first projection 61 is seen directly. The structures seen in FIGS. 4-8 show how a close packed arrangement within the electronics housing section 25 can be provided. Where four of the tire pressure sensors 21 are mounted on the tires of a vehicle, both the mechanical barrel assembly 23 and electronics housing section 25 must be sturdy and able to withstand centrifugal force from the spinning of the tire upon which they are mounted.

It should be noted that for a conventional tire pressure valve stem which extends directly toward the center of a tire, that the centrifugal force will work to push the transducer pushing structure 101, the membrane 95 and its flat area 97 in the direction of the tire valve stem. As a result, tire pressure measurement at high speed may produce a reading which is less than the same reading while the car is stopped.

Another consideration for the tire pressure sensor system 19 tire pressure sensor 21 is weight. The cover 57 is preferably as small as 21 millimeters square or smaller, and about 13 millimeters high. Thus in terms of an overall dimension, the tire pressure sensor system 19 tire pressure sensor 21 is roughly the size of a regulation die. It is preferable that the total weight of each tire pressure sensor 21 is light enough that the tire balance is not affected. Referring to FIG. 9, however, depending upon the total weight of the tire pressure sensor 21, a counterbalancing weight 131 may be provided for mounting on a conventional tire, opposite the location of the pressure valve assembly to provide balance. Because both the tire pressure sensor 21 and the outer mounted counter weight 131 are both located to the outside of the tire, a user would be capable of installing the counter weight 131 opposite the conventional tire pressure valve stem.

In the case of a larger, heavier tire pressure sensor 21 other structures for more secure mounting can be employed, as well as more substantial counterweights. In any event, the tire pressure sensor system 19 can be provided as a kit which includes four tire pressure sensors 21, four counter weights 131, and receiver 43. Where the tire pressure sensor 21 is of insignificant weight as to affect tire balance, the kit can be provided without the counter weights 131.

While the present invention has been described in terms of a tire pressure system, and particularly to a user mounted structure attached to a valve stem in the same manner as a valve stem cap, and which has the ability to derive power from its environs, the present invention may be applied in any situation where user installation is desired to yield a complete and integrated smart tire pressure system.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. A tire pressure system transmitter comprising:
a main housing having a first and a second end, said first end including for fitting over a conventional tire valve stem;
a pressure sensor mounted within said main housing;
a transmitter connected to said pressure sensor for receiving a sensed pressure and transmitting a signal associated with said sensed pressure;
a pressure pin extension adjacent said second end of said main housing positioned to depress a valve stem pressure pin upon attachment of said tire pressure system transmitter.

2. The tire pressure system transmitter as recited in claim 1 wherein said main housing further comprises a mechanical barrel assembly and an electronics housing section.

3. The tire pressure system transmitter as recited in claim 2 wherein said pressure sensor further comprises a pressure displacement diaphragm within said mechanical barrel assembly, a transducer pushing structure operable between said mechanical barrel assembly and said electronics housing section, and a transducer within said electronics housing section.
